(19) United States
(12) Patent Application Publication
(10) Pub. No.: US 2007/0272207 A1
(43) Pub. Date: Nov. 29, 2007

(54) Method and Device for Operating a Drive Unit

(76) Inventors: Christian Claudepierre, Bietigheim-Bissingen (DE); Rainer Hoepfinger, Kraichtal (DE); Thomas Reichenbach, Stuttgart (DE)

Correspondence Address: KENYON & KENYON LLP, ONE BROADWAY, NEW YORK, NY, 10004, US

(21) Appl. No.: 10/579,707

(22) PCT Filed: Oct. 7, 2004
(86) PCT No.: PCT/DE04/02221

§ 371 Date: May 14, 2007

(30) Foreign Application Priority Data
Dec. 11, 2003 (DE) 10357868.4

(51) Int. Cl. F02D 41/00

(52) U.S. Cl. 123/339.19

(57) ABSTRACT

A method and a device for operating a drive unit in a vehicle permit convenient transformation of a specified speed. A setpoint for at least one output variable of the drive unit is specified, and in at least one operating state of the drive unit, a setpoint for an operating variable of the drive unit is also specified, the at least one output variable of the drive unit being specified in this operating state regardless of its setpoint in the sense of approximating an actual value for the operating variable to the setpoint for the operating variable.

### FIELD OF THE INVENTION

The present invention is directed to a method and a device for operating a drive unit.

### BACKGROUND INFORMATION

It is already known that a setpoint for at least one output variable of the drive unit is specified for a drive unit for use in a motor vehicle, for example. This output variable is usually a torque. In conventional control systems for a drive unit in a motor vehicle, a setpoint for the torque of the vehicle's engine or a setpoint for an engine speed is specified, e.g., by the transmission control during a gear shifting operation or during an intervention measure by a vehicle dynamics control. Both specified values cannot be met at the same time because, due to the physical relationships, one value is obtained by specifying the other.

### SUMMARY

The method according to the present invention and the device according to the present invention for operating a drive unit have the advantage over the related art that a setpoint for an operating variable of the drive unit is also specified in at least one operating state of the drive unit, the at least one output variable of the drive unit being specified in this operating state regardless of its setpoint in the sense of approximating an actual value for the operating variable to the setpoint for the operating variable. In this way, in the at least one operating state, setting the setpoint of the operating variable has priority over setting the setpoint of the output variable of the drive unit. This may increase convenience in operation of the drive unit in the at least one operating state.

It is especially advantageous when the at least one operating state is selected as a start-up operating state of the drive unit. In this way, a transmission engagement operation, for example, is conveniently implementable with little effort without requiring a limitation on the output variable of the drive unit.

Another advantage is obtained when the setpoint for the at least one output variable is specified by a first control or first function and the setpoint for the operating variable is specified by the same control or function or a second control or second function and is relayed to a third control for setting the at least one output variable of the drive unit, and when the third control modifies this setpoint for the at least one output variable in the sense of approximating the actual value of the operating variable to the setpoint of the operating variable starting from the setpoint for the at least one output variable of the drive unit. This permits implementation of a superimposed setting of the setpoint of the operating variable after specifying the setpoint for the output variable, so the setpoint for the operating variable and the setpoint for the output variable are both largely transformable, priority being given to transformation of the setpoint for the operating variable. This may improve convenience in an external intervention measure, e.g., during a gear shifting operation.

The approximation of the actual value of the operating variable to the setpoint of the operating variable may be implemented in a particularly simple and uncomplicated manner by using a regulator, as a function of which the output variable of the drive unit is specified.

It is also advantageous if the setpoint for the at least one output variable is transformed without modification after the end of the at least one operating state. This ensures that the setpoint for the output variable is transformed with priority in the other operating states.

### BRIEF DESCRIPTION OF THE DRAWINGS

FIG. 1 shows a block diagram of a drive unit.

FIG. 2 shows a function block diagram to illustrate the functioning of the method according to the present invention and a first example embodiment of the device according to the present invention.

FIG. 3 shows a function block diagram to illustrate the functioning of the method according to the present invention and a second example embodiment of the device according to the present invention.

FIG. 4 shows a function block diagram to illustrate the functioning of the method according to the present invention and a third example embodiment of the device according to the present invention.

### DETAILED DESCRIPTION

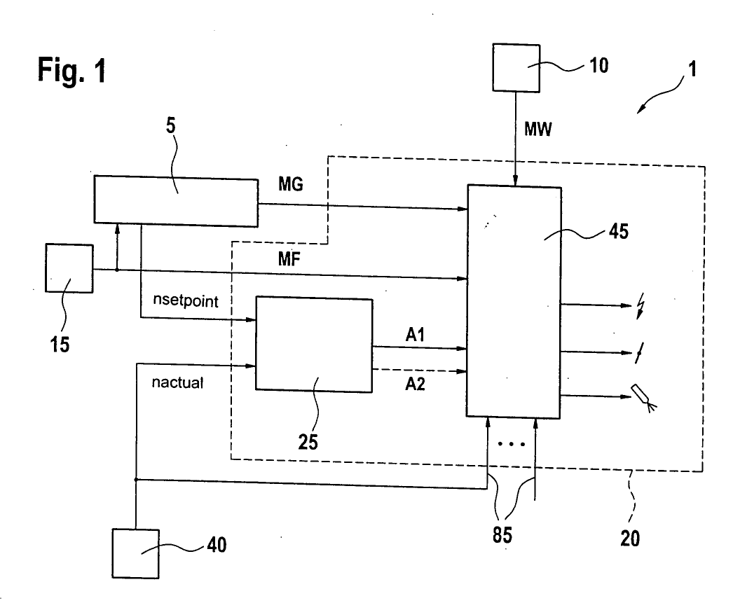

FIG. 1 shows a drive unit 1 of a motor vehicle, for example. In these examples, drive unit 1 includes a drive engine that delivers an output variable, for example, a torque, a power, or a cylinder filling in the case of an internal combustion engine, or a variable derived from one or more of the aforementioned variables. It is assumed below, for example, that the output variable of drive unit 1 is the output torque of the drive engine. This is also referred to as the internal torque of the drive engine and is supplied exclusively by combustion of an air/fuel mixture in the combustion chamber of the drive engine, assuming that the drive engine is an internal combustion engine. For example, this may be a gasoline engine or a diesel engine. It is assumed below as an example that the internal combustion engine is a gasoline engine.

According to FIG. 1, drive unit 1 includes an engine management system 20. Furthermore, a transmission control 5 is provided, triggering a transmission (not shown in FIG. 1) to establish a desired gear ratio between a crankshaft of the drive engine and a cardan shaft by a method familiar to those skilled in the art. During a gear shifting operation, transmission control 5 generates a torque request MG and a speed request nsetpoint. Torque request MG is relayed to a transformation unit 45 of engine management system 20. Speed request nsetpoint is sent to a speed regulator 25 of engine management system 20. Speed request nsetpoint is also referred to below as the setpoint speed. At the speed of the drive engine, this is an operating variable of drive unit 1 which is detected by a speed sensor 40 and as actual speed nactual is also supplied to speed regulator 25. Furthermore, a module 15 is provided, which may be designed as an accelerator pedal module or as a cruise control, and generates a specified torque MF for transformation of the driver's intent or the driving speed requested by the cruise control and relays this to transformation unit 45. Cruise control here represents a vehicle function. Another control or vehicle function 10 is also provided, e.g., vehicle dynamics control, traction control, an anti-lock system, etc., which requests an additional specified torque MW from transformation unit 45. Additional control or vehicle function 10 here is used symbolically for one or more such controls or vehicle functions, each being capable of generating such a specified torque and delivering it to transformation unit 45. Speed regulator 25 generates a first output variable A1 and, if necessary, a second output variable A2, which is also sent to transformation unit 45 and is formed in the sense of approximating speed actual value nactual to setpoint speed nsetpoint. Furthermore, transformation unit 45 is sent speed actual value nactual from speed sensor 40 and other operating variables 85 of drive unit 1, such as engine temperature, intake pressure, exhaust recycle rate, etc. Transformation unit 45 forms a resulting torque request from torque requests MG, MF, MW and output variables A1, A2, this torque request being transformed according to the prevailing operating conditions of drive unit 1 as per operating variables 85 supplied to it. With the gasoline engine described here, this transformation is accomplished through appropriate triggering of the ignition and/or air supply and/or fuel supply by a method familiar to those skilled in the art and as indicated by the appropriate symbols for ignition, air supply, and fuel supply in FIG. 1.

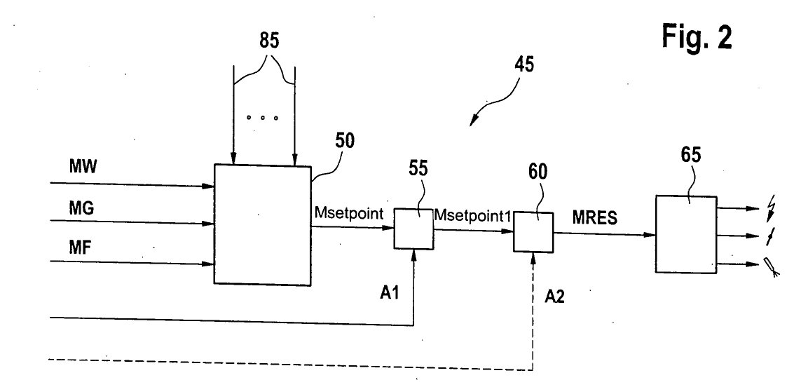

FIG. 2 shows a functional block diagram of a first exemplary embodiment of transformation unit 45. Torque requests MG, MF, MW are sent together with operating variables 85 of drive unit 1 to a torque coordinator 50 which forms from these variables a resulting setpoint MSETPOINT for the output torque of the drive engine by a method familiar to those skilled in the art. According to the first exemplary embodiment described here, speed regulator 25 generates a differential torque for reducing the difference between setpoint speed nsetpoint and speed actual value nactual as first output variable A1 by which resulting setpoint torque MSETPOINT must be modified to implement the described reduction in difference between speed setpoint nsetpoint and speed actual value nactual. To this end, first output variable A1 is additively linked, i.e., added, to resulting setpoint torque MSETPOINT in an adder 55, yielding a modified resulting setpoint torque MSETPOINT1 at the output of adder 55. Additionally or alternatively, speed regulator 25 may generate a factor for reducing the difference between speed setpoint nsetpoint and speed actual value nactual as a second output variable A2 by which resulting setpoint torque MSETPOINT and/or modified resulting setpoint torque MSETPOINT1 must be multiplied to achieve the desired reduction in difference between speed setpoint nsetpoint and speed actual value nactual. This multiplication is performed by using a multiplier 60; multiplier 60 is shown with dashed lines in FIG. 2. It is thus possible to provide for how the output of torque coordinator 50, i.e., resulting setpoint torque MSETPOINT, is first to be linked additively to first output variable A1, as shown in FIG. 2 and already described above, and for the modified resulting setpoint torque MSETPOINT1 to then be multiplied by multiplier 60 by second output variable A2 to ultimately obtain a resulting setpoint torque MRES that has been modified twice and is then set by a transformation module 65 in transformation unit 45 through corresponding triggering of the ignition and/or air supply and/or fuel supply. The order of addition and multiplication by adder 55 and multiplier 60 may also be switched. Alternatively, only additive correction using first output variable A1 or only multiplicative correction using second output variable A2 may be performed for modification of resulting setpoint torque MSETPOINT. In an operating state of drive unit 1 in which speed regulator 25 is turned off, e.g., by specifying the value zero as setpoint speed nsetpoint for speed regulator 25, first output variable A1 is equal to zero and second output variable A2 is equal to one. Thus, first output variable A1 may be different from zero and second output variable A2 may be different from one only in an operating state of drive unit 1 in which speed regulator 25 is activated. If drive unit 1 leaves the operating state in which speed regulator 25 was activated, then speed regulator 25 is turned off, first output variable A1 is set at zero, and second output variable A2 is set at one. Resulting setpoint torque MSETPOINT is thus transformed by transformation module 65 without modification during those operating states of drive unit 1 in which speed regulator 25 is turned off and/or after leaving such operating states in which speed regulator 25 was activated, as long as speed regulator 25 is turned off in the following operating state.

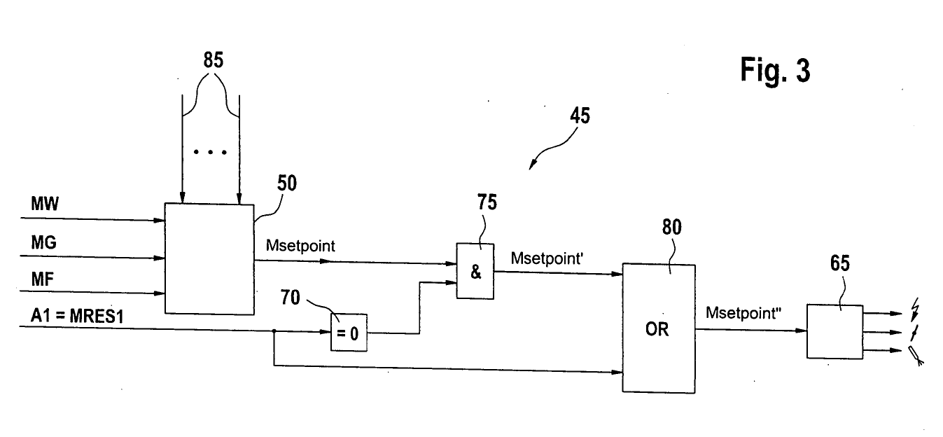

According to FIG. 3, a functional block diagram of a second embodiment of transformation unit 45 is depicted. The same reference numerals are used in FIG. 3 to denote the same elements as in FIG. 2. As in the first exemplary embodiment according to FIG. 2, torque requests MG, MF, MW together with operating variables 85 of drive unit 1 are sent to torque coordinator 50 which forms from these variables resulting setpoint MSETPOINT for the output torque of the drive engine by a method familiar to those skilled in the art. According to the second exemplary embodiment, shown in FIG. 3, speed regulator 25 forms only first output variable A1 in the form of an output torque MRES1 of the drive engine to be adjusted by engine management system 20 in the sense of reducing the difference between speed setpoint nsetpoint and speed actual value nactual. Output torque MRES1 that is supplied by speed regulator 25 and is to be set is sent to a comparator 70. Comparator 70 checks whether output torque MRES1 to be set is equal to zero. If this is the case, the output of comparator 70 is set at logic one; otherwise it is set at logic zero. The output signal of comparator 70 is sent together with the output signal of torque coordinator 50, i.e., resulting setpoint torque MSETPOINT, to an AND element 75. FIG. 3 shows the output of AND element 75 labeled as MSETPOINT′, corresponding to resulting setpoint torque MSETPOINT for the case when the output of comparator 70 is set, i.e., first output variable A1 and thus the output torque that is supplied by speed regulator 25 and is to be set is equal to zero. This is not a case of an operating state in which a setpoint speed is to be set, i.e., speed regulator 25 is turned off. This may be done, for example, by setting setpoint speed nsetpoint by transmission control 5 at zero and switching off speed regulator 25 when setpoint speed nsetpoint=0 is detected. However, if the output of comparator 70 has been reset because first output variable A1 is not equal to zero, then output MSETPOINT′ of AND element 75 is equal to zero. Output MSETPOINT′ of AND element 75 is sent to an OR element 80 together with first output variable A1=MRES1. For the case when first output variable A1 is equal to zero, output variable MSETPOINT″ of OR element 80 corresponds to output variable MSETPOINT′ of AND element 75, which in this case corresponds to resulting setpoint torque MSETPOINT at the output of torque coordinator 50. However, if first output variable A1 is not equal to zero, then output MSETPOINT″ of OR element 80 corresponds to first output variable A1 because in this case output variable MSETPOINT′ of AND element 75 is equal to zero. Output variable MSETPOINT″ is the output torque of the drive engine ultimately to be set; it is sent to transformation module 65 for transformation in the manner described for the first exemplary embodiment according to FIG. 2. This means that in an operating state of drive unit 1 in which speed regulator 25 is activated, transmission control 5 thus specifies a setpoint speed nsetpoint not equal to zero; output torque MSETPOINT″ of the drive engine ultimately to be set corresponds to first output variable A1 of speed regulator 25, the transformation of which thus has priority over transformation of torque requests MW, MG, MF. However, if speed regulator 25 is turned off, and setpoint speed nsetpoint is thus equal to zero, this is an operating state of drive unit 1 in which torque requests MW, MG, MF are to be transformed, taking into account the torque coordination.

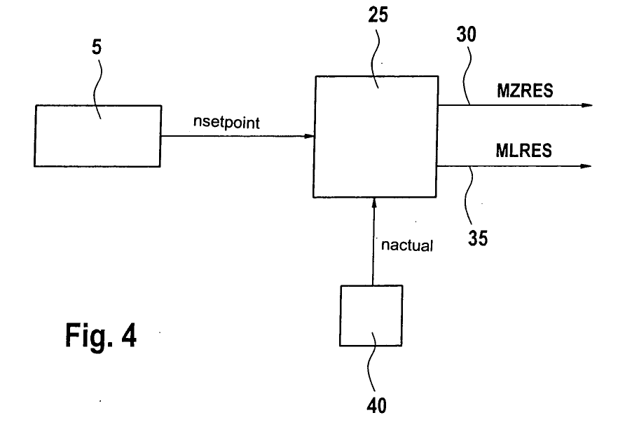

A functional block diagram of a third exemplary embodiment is shown in FIG. 4. The same reference numerals denote the same elements as in the previous figures. In contrast with the second exemplary embodiment, in the embodiment according to FIG. 4, speed regulator 25, which receives setpoint speed nsetpoint from transmission control 5 and receives actual speed nactual from speed sensor 40, determines two output torques to be set for the drive engine in the sense of reducing the difference between setpoint speed nsetpoint and actual speed nactual. A first output torque to be set for the drive engine in FIG. 4 is labeled as MZRES and a second output torque to be set for the drive engine is labeled as MLRES. First output torque MZRES to be set is an output torque to be transformed on an ignition path of the drive engine designed as an internal combustion engine and second output torque MLRES to be set is an output torque to be transformed on an air path and/or fuel path of the drive engine designed as an internal combustion engine. The structure of the function chart shown in FIG. 2 is provided in duplicate for this case, namely once for the ignition path and once for the air path and/or fuel path. Only torque coordinator 50 is necessary just once and in this case supplies a first resulting setpoint torque for the ignition path instead of resulting setpoint torque MSETPOINT and supplies a second resulting setpoint torque for the air path and/or fuel path. In addition, the transformation module provided for the ignition path is designed only for transformation of the output torque ultimately required for the ignition path through appropriate triggering of the ignition, and the transformation module provided for the air path and/or fuel path is designed only for transformation of the output torque ultimately required for the air path and/or fuel path through appropriate triggering of the air supply and/or fuel supply. The division between the ignition path and the air path and/or fuel path for specification and transformation of torque is essentially already included in the related art and allows distribution of the total output torque of the drive engine that is to be transformed into a rapidly transformable component via the ignition path and a more slowly transformable component via the air path and/or the fuel path.

The two embodiments according to FIGS. 2 and 3 have in common the fact that in an operating state of drive unit 1 in which speed regulator 25 is activated, the regulation of actual speed nactual at setpoint speed nsetpoint has priority over the transformation of torque requests MW, MG, MF. In the case of the first exemplary embodiment according to FIG. 2, this is implemented by a superimposed speed regulator in which resulting setpoint torque MSETPOINT supplied by torque coordinator 50 is modified as a function of the speed regulator so that modified resulting setpoint torque MSETPOINT1 and/or twice-modified resulting setpoint torque MRES is obtained for transformation via transformation module 65. In the case of the second exemplary embodiment according to FIG. 3, this is implemented by assigning priority to output torque MRES1, which has been requested and is to be set by speed regulator 25, over resulting setpoint torque MSETPOINT determined by torque coordinator 50 in transformation via transformation module 65.

Use of the first exemplary embodiment according to FIG. 2 may be advantageous for an operating state of drive unit 1, for example, which is characterized by a gear shifting operation. During the gear shifting operation, transmission control 5 sends a speed request in the form of setpoint speed nsetpoint to speed regulator 25 and also sends torque request MG to torque coordinator 50. Regardless of other torque requests MW, MF, torque request MG of transmission control 5 is applied to the input of torque coordinator 50. From torque request MG of transmission control 5, torque coordinator 50 ascertains resulting setpoint torque MSETPOINT as a function of operating variables 85. This resulting setpoint torque MSETPOINT is then modified by speed regulator 25 to set setpoint speed nsetpoint. This is thus a superimposed speed regulator with a specified torque, initially taking into account torque request MG of transmission control 5 and/or setpoint torque MSETPOINT derived therefrom and modifying it according to speed regulator 25.

Speed regulator 25 is limited to increasing or reducing resulting setpoint torque MSETPOINT, depending on the sign in front of first output variable A1, i.e., whether second output variable A2 is greater than or less than one. With the help of the superimposed speed regulator described here combined with specification of torque, it is possible to comply with specified speed values as well as specified torque values at the same time, thereby improving the convenience of an external intervention measure such as that occurring during the operating state of drive unit 1 characterized by the gear shifting operation.

Use of the second exemplary embodiment according to FIG. 3 may be advantageous, for example, for an operating state of drive unit 1 that is characterized by a start-up operation of the vehicle. The traditional procedure for such a start-up operation of the vehicle specifies that when starting a vehicle, the driver requests output torque MF of the drive engine via the accelerator pedal, this output torque then being modified, if necessary, by a torque coordinator and also transformed by the engine management system. When using an automated gear-shift transmission, the clutch begins to engage then, so the drive engine does not run the risk of dying or revving up too high. Only a torque limit is sent to the engine management system by the transmission control of the automated gear-shift transmission, so the clutching operation nevertheless remains controllable at the high output torques required of the drive engine.

According to the present invention, with the second exemplary embodiment according to FIG. 3, and on the basis of the block diagram according to FIG. 1, when the driver depresses the accelerator pedal when the vehicle is stationary and/or at a low driving speed, so that a start-up operation is required, specified torque MF thereby generated for the driver's intent according to FIG. 1 is also sent to transmission control 5, so that transmission control 5 recognizes the start request and activates speed regulator 25 for this operating state of the starting operation by forming a suitable setpoint speed nsetpoint which is not equal to zero for the start-up operation. The setpoint speed of transmission control 5 is then taken into account only if it is greater than the steady-state idling setpoint speed. If the steady-state idling setpoint speed is greater than setpoint speed nsetpoint specified by transmission control 5, then for safety reasons, instead of setpoint speed nsetpoint of transmission control 5, the steady-state idling setpoint speed is sent to speed regulator 25. As long as the start-up operation and thus speed regulator 25 remains active, specified torque MF for the driver's intent and/or resulting setpoint torque MSETPOINT linked thereto at the output of torque coordinator 50 is ignored according to the second exemplary embodiment and only output torque MRES1 which is requested by speed regulator 25 and is to be set is taken into account and transformed in the manner described here for transformation of setpoint speed nsetpoint. In this operating state, the accelerator pedal thus has no effect on the output torque of the drive engine; by operating the accelerator pedal, only transmission control 5, which influences the required output torque of the drive engine, is affected by the specification of setpoint speed nsetpoint and the clutch engagement speed. The operating state of the start-up operation is recognized as ended by transmission control 5, for example, when the accelerator pedal is at least partially released again. The specification of setpoint speed nsetpoint to speed regulator 25 is then terminated, i.e., setpoint speed nsetpoint is set at zero and speed regulator 25 is thereby shut down. Thus on conclusion of the operating state of the start-up operation, specified torque MF according to the driver's intent and/or resulting setpoint torque MSETPOINT linked thereto is thus taken into account again for transformation by transformation module 65. The start-up operation may be made more convenient by stopping setpoint speed nsetpoint during the start-up operation, assuming setpoint speed nsetpoint has already been applied suitably beforehand for the start-up operation, e.g., on a test stand. The output torque of the drive engine to be set by engine management system 20 may additionally be superimposed (by a method not depicted in the figures) on the result of a torque precontrol. Another precontrol torque is superimposed on the output torque to be transformed from the drive engine prior to transformation, this output torque being sent to transformation module 65 in the exemplary embodiments according to FIGS. 2 and 3. The precontrol torque takes into account, for example, friction losses of the drive engine, losses of consumers such as the air conditioning system, electric sunroof, etc., torque demand due to the clutch position, etc.

Speed regulator 25 may include an integral regulator and/or a proportional regulator and/or a differential regulator. Speed regulator 25 may be designed as a PID regulator, for example. The operating states of drive unit 1 in which speed regulator 25 is to be activated according to the present invention in a manner described here are different from an idling speed regulator of drive unit 1. Nevertheless, the structure of an existing idling speed regulator of drive unit 1 may be used for speed regulator 25, for example. The same regulators may be used here as for the conventional idling speed regulator; only the regulating parameters need be adjusted as a function of the various operating states of drive unit 1, i.e., idling or start-up operation or shifting, for example. This requires differentiation of the various operating states. In this case, information about the prevailing operating state in which speed regulator 25 is to be active must be supplied to speed regulator 25 as a function of the particular operating state. The prevailing operating state of drive unit 1 and thus, for example, the idling operating state, the operating state of the startup operation, and the operating state of the shifting operation may be determined by engine management system 20 as a function of operating variables 85 by a method familiar to those skilled in the art and this information may be reported to speed regulator 25 for adjusting the regulating parameters. In this way resources in the form of computation power in particular may be saved through the use of the same regulators for the speed regulator in various operating states of drive unit 1.

Transmission control 5 may be designed, for example, as a standard manual transmission, an automated gear-shift transmission, an infinitely variable speed transmission, or an automatic transmission.

1-11. (canceled)

12. A method for operating a drive unit of a vehicle, comprising:
specifying a setpoint for at least one output variable of the drive unit; and
specifying a setpoint for an operating variable of the drive unit in at least one operating state of the drive unit;
wherein, in the at least one operating state of the drive unit, the at least one output variable of the drive unit is specified regardless of the setpoint for the at least one output variable, by approximating an actual value for the operating variable to the setpoint for the operating variable.

13. A method for operating a drive unit of a vehicle, comprising:
specifying a setpoint for at least one output variable of the drive unit;
specifying a setpoint for an operating variable of the drive unit in at least one operating state of the drive unit; and
modifying the at least one output variable of the drive unit in the at least one operating state of the drive unit, starting from the setpoint for the at least one output variable, by approximating an actual value for the operating variable to the setpoint for the operating variable;
wherein the at least one operating state of the drive unit includes a gear shift operation of a transmission.

14. The method as recited in claim 12, wherein the at least one output variable is one of a torque and a power of the drive unit.

15. The method as recited in claim 13, wherein the at least one output variable is one of a torque and a power of the drive unit.

16. The method as recited in claim 12, wherein the operating variable is a speed of an engine of the drive unit.

17. The method as recited in claim 13, wherein the operating variable is a speed of an engine of the drive unit.

18. The method as recited in claim 12, wherein the at least one operating state is a start-up operating state of the drive unit.

19. The method as recited in claim 13, wherein the at least one operating state is a start-up operating state of the drive unit.

20. The method as recited in claim 12, wherein the at least one output variable of the drive unit is specified by a regulator.

21. The method as recited in claim 12, wherein the drive unit is operated with an internal combustion engine, and wherein a first output variable of the drive unit is specified for an ignition path of the internal combustion engine, and a second output variable of the drive unit is specified for an air path of the internal combustion engine.

22. The method as recited in claim 13, wherein the drive unit is operated with an internal combustion engine, and wherein a first output variable of the drive unit is specified for an ignition path of the internal combustion engine, and a second output variable of the drive unit is specified for an air path of the internal combustion engine.

23. The method as recited in claim 12, wherein the setpoint for the at least one output variable is implemented without modification after the end of the at least one operating state.

24. A device for operating a drive unit of a vehicle, comprising:
an arrangement for specifying a setpoint for at least one output variable of the drive unit;
a first specification unit for specifying a setpoint for an operating variable of the drive unit in at least one operating state of the drive unit; and
a second specification unit for specifying, in the at least one operating state, the at least one output variable of the drive unit regardless of the setpoint for the at least one output variable, by approximating an actual value for the operating variable to the setpoint for the operating variable.

25. A device for operating a drive unit of a vehicle, comprising:
an arrangement for specifying a setpoint for at least one output variable of the drive unit;
a first specification unit for specifying a setpoint for an operating variable of the drive unit in at least one operating state of the drive unit;
an arrangement for modifying the at least one output variable of the drive unit in the at least one operating state of the drive unit, starting from the setpoint for the at least one output variable, by approximating an actual value for the operating variable to the setpoint for the operating variable;
wherein the at least one operating state of the drive unit includes a gear shift operation of a transmission.
